(19) United States
(12) Patent Application Publication
(10) Pub. No.: US 2025/0219201 A1
(43) Pub. Date: Jul. 3, 2025

(54) EXTERIOR MATERIAL FOR RECHARGEABLE LITHIUM BATTERY AND RECHARGEABLE LITHIUM BATTERY INCLUDING SAME

(71) Applicant: SAMSUNG SDI CO., LTD., Gyeonggi-do (KR)

(72) Inventors: Tae Jin LEE, Gyeonggi-do (KR); Myungheui WOO, Gyeonggi-do (KR); Sanghoon KIM, Gyeonggi-do (KR); Arum YU, Gyeonggi-do (KR)

(73) Assignee: SAMSUNG SDI CO., LTD., Gyeonggi-do (KR)

(21) Appl. No.: 18/853,022

(22) PCT Filed: Aug. 18, 2022
(86) PCT No.: PCT/KR2022/012330

§ 371 Date: Sep. 30, 2024

(30) Foreign Application Priority Data
Apr. 1, 2022 (KR) 10-2022-0041242

(51) Int. Cl. H01M 50/121; H01M 4/525; H01M 10/052; H01M 50/105; H01M 50/107; H01M 50/124; H01M 50/133

(52) U.S. Cl. CPC H01M 50/121; H01M 4/525; H01M 10/052; H01M 50/105; H01M 50/107; H01M 50/124; H01M 50/1245; H01M 50/133

(57) ABSTRACT

Disclosed are an exterior material for a rechargeable lithium battery and a rechargeable lithium battery including the same. An example embodiment provides an exterior material for a rechargeable lithium battery including a substrate; and a coating layer on an inner surface of the substrate, the coating layer including one or more metal organic frameworks selected from ZIF-8, MOF-177, Al-MIL-53, and Fe-BTC.

### TECHNICAL FIELD

An exterior material for a rechargeable lithium battery and a rechargeable lithium battery including the same are disclosed.

### BACKGROUND ART

Rechargeable lithium batteries are in the spotlight as power sources for driving medium to large devices such as hybrid vehicles and battery vehicles as well as small devices such as mobile phones, notebook computers, and smart phones.

When these rechargeable lithium batteries are exposed to misuse conditions such as overcharging and the like and extreme conditions such as heat exposure and the like, while thermal runaway occurs, since an amount of gas generated thereinside and thus sharply increases, the rechargeable lithium batteries may explode.

A method of reducing the amount of generated gas by coating the surface of an active material or by adding a film-forming additive to an electrolyte is known to some extent. However, the method is no longer effective, when the rechargeable lithium batteries enter a thermal runaway situation due to a short circuit.

### DISCLOSURE

### Technical Problem

An embodiment is to suppress a rapid increase of an amount of gas generated in a rechargeable lithium battery when it enters a thermal runaway situation.

### Technical Solution

In an embodiment, an exterior material for a rechargeable lithium battery includes a substrate; and a coating layer located on the inner surface of the substrate and including a metal organic framework (MOF) of ZIF-8, MOF-177, Al-MIL-53, Fe-BTC, or a combination thereof.

Another embodiment provides a rechargeable lithium battery including the exterior material for a rechargeable lithium battery.

### Advantageous Effects

In the exterior material for a rechargeable lithium battery of the embodiment, the metal organic framework is a material capable of effectively trapping gas through an adsorption reaction.

Accordingly, a rechargeable lithium battery including an exterior material having an inner surface coated with a metal organic framework structure, which is ZIF-8, MOF-177, AI-MIL-53, Fe-BTC, or a combination thereof, has a significantly reduced risk of explosion even when a thermal runaway situation is entered and the amount of gas generated inside thereof rapidly increases, as the metal organic framework captures the rapidly increasing gas.

### DESCRIPTION OF THE DRAWINGS

FIG. 1 is a schematic view illustrating a rechargeable lithium battery according to an embodiment.

FIGS. 2A to 2C show the evaluation of the opening time of a current interruptive device (CID) at high temperatures for the rechargeable lithium battery cells of examples and comparative examples.

FIGS. 3A to 3C show evaluations of temperature and voltage during heat exposure for the rechargeable lithium battery cells of examples and comparative examples.

FIG. 4 illustrates various examples of shapes (patterns) of a coating layer formed on an exterior material for a rechargeable lithium battery according to one embodiment.

FIGS. 5A to 5C show evaluations of whether cells explode during overcharge for the rechargeable lithium battery cells of examples.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

“Combination thereof” refers to a mixture, a laminate, a composite, a copolymer, an alloy, a blend, a reaction product, and the like of constituents.

It should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

The “layer” includes not only a shape formed on the whole surface when viewed from a plan view, but also a shape formed on a partial surface.

The “particle diameter” or “average particle diameter” may be measured by a method well known to those skilled in the art, for example, may be measured by a particle size analyzer, or may be measured by a transmission electron micrograph or a scanning electron micrograph. Alternatively, it is possible to obtain an average particle diameter value by measuring using a dynamic light scattering method, performing data analysis, counting the number of particles for each particle size range, and calculating from this. Unless otherwise defined, the average particle diameter may mean a diameter (D50) of particles having a cumulative volume of 50 volume % in the particle size distribution.

The “thickness” may be measured through a photograph taken with a thickness meter or an optical microscope such as a scanning electron microscope. Additionally, the “area” may be measured through photographs taken with an optical microscope, such as a scanning electron microscope.

### (Exterior Material for Rechargeable Lithium Battery)

In an embodiment, an exterior material for a rechargeable lithium battery includes a substrate; and a coating layer located on the inner surface of the substrate and including a metal organic framework (MOF) of ZIF-8, MOF-177, Al-MIL-53, Fe-BTC, or a combination thereof.

The metal organic framework is a material capable of effectively trapping gas through an adsorption reaction. In particular, a rechargeable lithium battery including an exterior material having an inner surface coated with a metal organic framework structure of ZIF-8, MOF-177, AI-MIL-53, Fe-BTC, or a combination thereof has a significantly reduced risk of explosion even when a thermal runaway situation is entered and the amount of gas generated therein rapidly increases, as the metal organic framework captures the rapidly increasing gas.

Hereinafter, the exterior material for a rechargeable lithium battery of the embodiment will be described in detail.

### Structure of Metal Organic Framework

The metal organic framework is a material in which clusters including metal ions or metals are connected by organic ligands, and is a type of coordination polymer. The metal organic framework has a cage that is an empty space therein by forming a three-dimensional structure. As a result, the metal organic framework may undergo an adsorption reaction through the cage and trap gas into the cage.

On the other hand, zeolite, which is a crystalline aluminum silicate mineral, has an inferior gas trapping effect, compared with the metal organic framework. The gas adsorption reaction is a reaction in which gas molecules are adsorbed on the surface of a cage inside the material structure. In general, the larger a specific surface area, the more gas molecules may be adsorbed. According to the results of several previous studies, which compare specific surface areas of zeolite and representative materials with the metal organic framework, the metal organic framework has been reported to have a larger specific surface area than that of the zeolite. Accordingly, the metal organic framework may have a larger surface area for gas adsorption than the zeolite. Particularly, in a rechargeable lithium battery using a nickel-based positive electrode active material including 90% or more of Ni as a positive electrode active material, the metal organic framework exhibits a very excellent gas trapping effect, but the zeolite exhibits a very inferior gas trapping effect. This fact is confirmed in evaluation examples described later.

Structural and compositional characteristics of the metal organic framework may be usefully utilized in formation charging and discharging and thermal runaway situations of a rechargeable lithium battery. Specifically, when the sheet for a rechargeable lithium battery according to one embodiment is disposed inside the rechargeable lithium battery, an increase in battery volume and an increase in internal pressure may be prevented by trapping gas generated inside the rechargeable lithium battery during the first cycle charge and discharge (i.e., formation charge and discharge). Furthermore, even when the rechargeable lithium battery enters a thermal runaway situation where a short circuit occurs due to overcharge, heat exposure, and the like, the metal organic framework may effectively collect gas components (e.g., H₂, CO, CO₂, and the like) rapidly increasing inside the rechargeable lithium battery, so that the rechargeable lithium battery may be significantly less likely exploded.

In particular, in the exterior material for a rechargeable lithium battery of the embodiment, the metal organic framework may include ZIF-8, MOF-177, Al-MIL-53, Fe-BTC, or a combination thereof, and each structure is as follows:

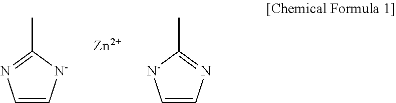

The ZIF-8 is represented by Chemical Formula 1, the coordination metal is Zn, and the linker is 2-methylimidazole. The ZIF-8 has a pore volume of 0.66 cm³/g and a BET specific surface area of 1300 to 1800 m²/g.

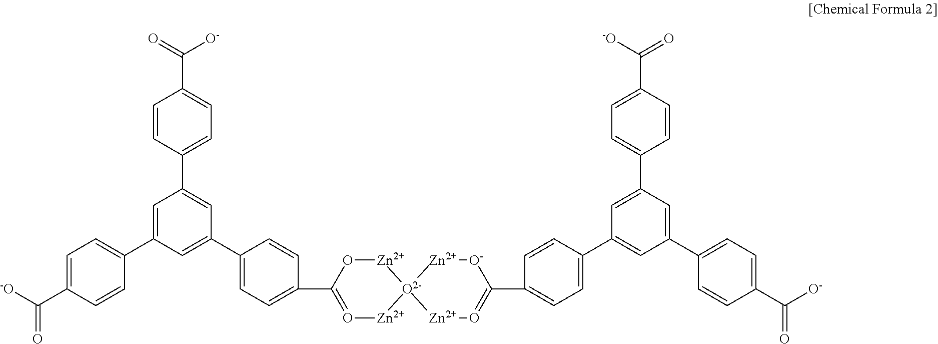

The MOF-177 is represented by Chemical Formula 2, the coordination metal is Zn, and the linker is H3BTB. The MOF-177 has a pore volume of 1.6 g/cm³ and a BET specific surface area of 3800 to 4000 m²/g.

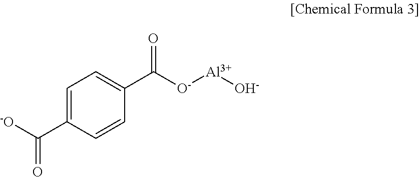

The Al-MIL-53 is represented by Chemical Formula 3, the coordination metal is Al, and the linker is terephthalic acid. The HKUST-1 has a pore volume of 0.7 g/cm³ and a BET specific surface area of 1100 to 1500 m²/g.

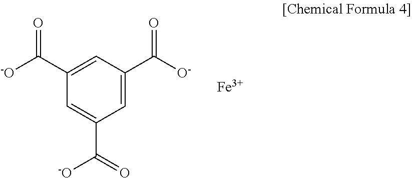

The Fe-BTC is represented by Chemical Formula 4, the coordination metal is Fe, and the linker is 1,3,5-benzenetricarboxylic acid. The Fe-BTC has a pore volume of 0.9 g/cm³ and a BET specific surface area of 1300 to 1600 m²/g.

According to the evaluation examples described below, the ZIF-8, MOF-177, AI-MIL-53, and Fe-BTC have significantly superior gas capture effects not only than zeolites but also than other metal organic frameworks (e.g., MIL-100 (Fe), MIL-101 (Fe), MIL-127 (Fe), MOF-74 (Co), Cu-BTC, CPO-27, etc.).

Previous studies on metal organic frameworks known to date have shown that cations increase a polarity of metal organic frameworks, thereby enhancing physical adsorption of gas molecules, and anions increase chemical adsorption through coordination bonding of unshared electron pairs.

In this regard, it is presumed that the gas capture effects of the ZIF-8, MOF-177, AI-MIL-53, and Fe-BTC are significantly superior to those of not only zeolites but also other metal organic frameworks because the synergistic effects of physical adsorption and chemical adsorption for gas components (e.g., H₂, CO, CO₂, etc.) generated from rechargeable lithium batteries are maximized due to the molecular structure.

### Adhesive

The coating layer may further include an adhesive. Specifically, the coating layer may be formed by dispersing the metal organic framework with the adhesive. More specifically, the adhesive may be a spray adhesive that facilitates the spraying, wherein any spray adhesive widely used in the related art (e.g., a product of 3M) may be used without particular limits.

### Thickness and Area of Coating Layer

A thickness ratio of the coating layer to the substrate (coating layer thickness/substrate thickness) may be 1/1000 to 5. For example, the thickness ratio of the coating layer to the substrate (coating layer thickness/substrate thickness) may be greater than or equal to 1/1000, greater than or equal to 1/100, or greater than or equal to 1/10, and less than or equal to 5, less than or equal to 4.2, less than or equal to 4, less than or equal to 3, less than or equal to 2, or less than or equal to 1.

Specifically, the coating layer may have a thickness of greater than or equal to 200 nm. For example, the thickness of the coating layer may be greater than or equal to 200 nm, greater than or equal to 1 μm, greater than or equal to 5 μm, or greater than or equal to 10 μm and less than or equal to 5 mm, less than or equal to 3 mm, or less than or equal to 1 mm.

If the coating layer to the substrate has a thickness ratio (coating layer thickness/substrate thickness) of less than 1/1000, while the thickness of the coating layer is less than 200 nm, the gas capture effect of the metal organic framework may be insignificant. Unlike this, if the thickness ratio of the coating layer to the substrate (coating layer thickness/substrate thickness) is greater than 5, while the thickness of the coating layer is greater than 5 mm, the gas capture effect tends to be saturated.

On the other hand, an area ratio of the coating layer to the substrate (coating layer area/substrate area) may be 2/10 to 1. For example, the area ratio of the coating layer to the substrate (coating layer area/substrate area) may be greater than or equal to 2/10, greater than or equal to 3/10, or greater than or equal to 4/10 and less than or equal to 1.

If the area ratio of the coating layer to the substrate (coating layer area/substrate area) is less than 2/10, the gas capture effect of the metal organic framework may be insignificant. Unlike this, as the area ratio of the coating layer to the substrate (coating layer area/substrate area) becomes larger within a range of 2/10 or more, the gas capture effect may be increased.

For reference, the “thickness” may be measured through a photograph taken with a thickness meter or a scanning electron microscope such as an optical microscope and the like. In addition, if the coating layer further includes the adhesive, the thickness and the area of the coating layer in the exterior material may respectively include a thickness and an area by the adhesive.

For example, the thickness of the coating layer in the exterior material may be measured by cutting the exterior material in a thickness direction and measuring a length between the lowest and highest ends of the coating layer with a commercially available thickness measuring device or alternatively, obtained by taking an image of the cut surface with an optical microscope such as a scanning electron microscope and the like and then, calculating a length between the lowest and highest ends of the coating layer shown in the image.

On the other hand, the area of the coating layer in the exterior material may be measured by taking an image of the exterior material from top with the optical microscope such as an scanning electron microscope and the like and calculating an coating layer area shown in the image,

### Shape (Pattern) of Coating Layer

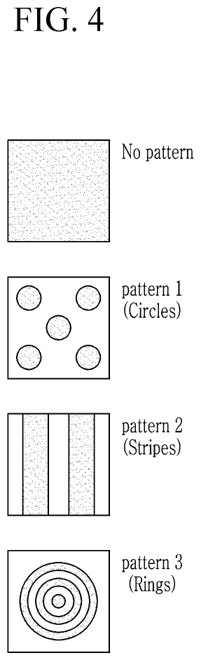

The coating layer may be patterned. In this way, the gas diffusion area is expanded in the patterned coating layer, and thus the gas capture effect can be further enhanced. Specifically, FIG. 4 illustrates various examples of shapes (patterns) of a coating layer formed on the exterior material for a rechargeable lithium battery according to an embodiment. The coating layer may be patterned into a plurality of circles, stripes, rings, or a combination thereof. However, the embodiment is not limited thereto and may include a non-patterned coating layer, in which case excellent gas capture effects may also be exhibited.

### Method for Forming Coating Layer

Any method that may be used in the relevant technical field may be used to form the coating layer.

Specifically, the exterior material may be completed through a process of spraying the metal organic framework structure, which is ZIF-8, MOF-177, Al-MIL-53, Fe-BTC, or a combination thereof, onto the substrate together with an appropriate spray adhesive (e.g., a 3M product). The spraying method may use spray coating, but is not limited thereto, and materials and methods widely known in the art may be used.

### Shape of Exterior Material

The description of the exterior material may have a structure, material, etc. generally known in the art as a can-shaped (specifically, a cylindrical can-shaped) exterior material or a pouch-shaped exterior material. Accordingly, the exterior material of the embodiment may be a material in which the metal organic framework structure is coated on the inner surface of the can-shaped exterior material or the pouch-shaped exterior material.

### (Rechargeable Lithium Battery)

In another embodiment, a rechargeable lithium battery is provided including the sheet for a rechargeable lithium battery of the aforementioned embodiment.

A rechargeable lithium battery including the exterior material having an inner surface coated with at least one metal organic framework structure selected from the above ZIF-8, MOF-177, AI-MIL-53, and Fe-BTC has a significantly reduced risk of explosion even when a thermal runaway situation is entered and the amount of gas generated inside thereof rapidly increases, as the metal organic framework structure captures the rapidly increasing gas.

Hereinafter, the rechargeable lithium battery is described in detail, excluding any explanation that overlaps with the above-mentioned contents.

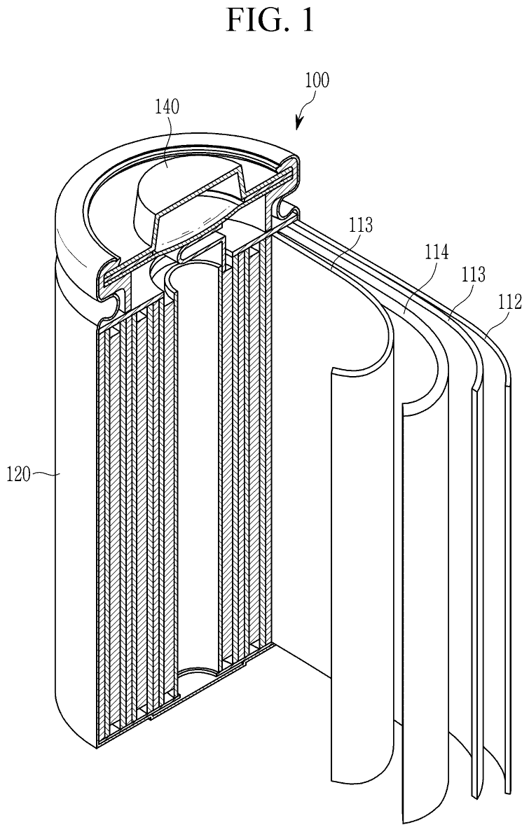

FIG. 1 is a schematic view illustrating a rechargeable lithium battery according to an embodiment. Referring to FIG. 1, a rechargeable lithium battery 100 according to an embodiment has a cylindrical can shape including a battery cell including a positive electrode 114, a negative electrode 112 facing the positive electrode 114, a separator 113 between the positive electrode 114 and the negative electrode 112, and an electrolyte (not shown) for a rechargeable lithium battery impregnating the positive electrode 114, the negative electrode 112, and the separator 113, a battery case 120 housing the battery cell, and a sealing member 140 sealing the battery case 120. Of course, the rechargeable lithium battery according to an embodiment is not limited to the cylindrical can shape, and it is obvious that any shape such as a pouch shape, square shape, coin shape, etc. is possible as long as it includes an electrolyte solution for a rechargeable lithium battery according to an embodiment and can operate as a battery. In particular, the rechargeable lithium battery of an embodiment may be in a cylindrical can shape or a pouch shape.

### Positive Electrode

The positive electrode includes a current collector and a positive electrode active material layer on the current collector.

The positive electrode active material layer includes a positive electrode active material and may further include a binder and/or a conductive material.

As the positive electrode active material, a compound capable of reversible intercalation and deintercalation of lithium (a lithiated intercalation compound) may be used. Examples of the positive electrode active material include a compound represented by any one of the following formulas:

LiₐA_{1-b}X_{b}D₂ (0.90≤a≤1.8,0≤b≤0.5);

LiₐA_{1-b}X_{b}O_{2-c}D_{c} (0.90≤a≤1.8,0≤b≤0.5,0≤c≤0.05);

LiₐE_{1-b}X_{b}O_{2-c}D_{c} (0.90≤a≤1.8,0≤b≤0.5,0≤c≤0.05);

LiₐE_{2-b}X_{b}O_{4-c}D_{c} (0.90≤a≤1.8,0≤b≤0.5,0≤c≤0.05);

LiₐNi_{1-b-c}CO_{b}X_{c}D_{α} (0.90≤a≤1.8,0≤b≤0.5,0≤c≤0.5,0<α≤2);

LiₐNi_{1-b-c}CO_{b}X_{c}O_{2-α}T_{α} (0.90≤a≤1.8,0≤b≤0.5,0≤c≤0.05,0<α<2);

LiₐNi_{1-b-c}CO_{b}X_{c}O_{2-α}T₂ (0.90≤a≤1.8,0≤b≤0.5,0≤c≤0.05,0<α<2);

LiₐNi_{1-b-c}Mn_{b}X_{c}D_{α} (0.90≤a≤1.8,0≤b≤0.5,0≤c≤0.05,0<α≤2);

LiₐNi_{1-b-c}Mn_{b}X_{c}O_{2-α}T_{α} (0.90≤a≤1.8,0≤b≤0.5,0≤c≤0.05,0<α<2);

LiₐNi_{1-b-c}Mn_{b}X_{c}O_{2-α}T₂ (0.90≤a≤1.8,0≤b≤0.5,0≤c≤0.05,0<α<2);

LiₐNi_{b}E_{c}G_{d}O₂ (0.90≤a≤1.8,0≤b≤0.9,0≤c≤0.5,0.001≤d≤0.1);

LiₐNi_{b}Co_{c}Mn_{d}GₑO₂ (0.90≤a≤1.8,0≤b≤0.9,0≤c≤0.5,0≤d≤0.5,0.001≤e≤0.1);

LiₐNiG_{b}O₂ (0.90≤a≤1.8,0.001≤b≤0.1);

LiₐCoG_{b}O₂ (0.90≤a≤1.8,0.001≤b≤0.1);

LiₐMn_{1-b}G_{b}O₂ (0.90≤a≤1.8,0.001≤b≤0.1);

LiₐMn₂G_{b}O₄ (0.90≤a≤1.8,0.001≤b≤0.1);

LiₐMn_{1-g}G_{g}PO₄ (0.90≤a≤1.8,0≤g≤0.5);

QO₂; QS₂; LiQS₂;

V₂O₅; LiV₂O₅;

LiZO₂;

LiNiVO₄;

Li_{(3-f)}J₂(PO₄)₃ (0≤f≤2);

Li_{(3-f)}Fe₂(PO₄)₃ (0≤f≤2);

LiₐFePO₄ (0.90≤a≤1.8).

In the above chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a combination thereof. The coating layer forming process may use a method that does not adversely affect the physical properties of the positive electrode active material, for example, spray coating, dipping, and the like.

For example, the positive electrode may include a composite oxide of lithium and at least one metal selected from nickel, cobalt, manganese, and aluminum as a positive electrode active material.

The positive electrode active material may include, for example, a lithium nickel composite oxide represented by Chemical Formula 11.

Liₐ₁₁Niₓ₁₁M¹¹_{y11}M¹²_{1-x11-y12}O₂ [Chemical Formula 11]

In Chemical Formula 11, 0.9≤a11≤1.8, 0.3≤x11≤1, 0≤y11≤0.7, and M₁₁ and M¹² are independently are selected from Al, B, Ce, Co, Cr, F, Mg, Mn, Mo, Nb, P, S, Si, Sr, Ti, V, W, Zr, and a combination thereof.

In Chemical Formula 11, 0.4≤x11≤1 and 0≤y11≤0.6; 0.5≤x11≤1 and 0≤y11≤0.5; 0.6≤x11≤1 and 0≤y11≤0.4; 0.7≤x11≤1 and 0≤y11≤0.3; 0.8≤x11≤1 and 0≤y11≤0.2; or 0.9≤x11≤1 and 0≤y11≤0.1.

As a specific example, the second positive electrode active material may include a lithium nickel cobalt composite oxide represented by Chemical Formula 12.

Liₐ₁₂Niₓ₁₂CO_{y12}M¹³_{1-x12-y12}O₂ [Chemical Formula 12]

In Chemical Formula 12, 0.9≤a12≤1.8, 0.3≤x12<1, 0<y12≤0.7, and M¹³ is selected from Al, B, Ce, Cr, F, Mg, Mn, Mo, Nb, P, S, Si, Sr, Ti, V, W, Zr, and a combination thereof.

In Chemical Formula 12, 0.3≤x12≤0.99 and 0.01≤y12≤0.7; 0.4≤x12≤0.99 and 0.01≤y12≤0.6; 0.5≤x12≤0.99 and 0.01≤y12≤0.5; 0.6≤x12≤0.99 and 0.01≤y12≤0.4; 0.7≤x12≤0.99 and 0.01≤y12≤0.3; 0.8≤x12≤0.99 and 0.01≤y12≤0.2; or 0.9≤x12≤0.99 and 0.01≤y12≤0.1.

As a specific example, the positive electrode active material may include a lithium nickel cobalt composite oxide represented by Chemical Formula 13.

Liₐ₁₃Niₓ₁₃CO_{y13}M¹⁴_{z13}M¹⁵_{1-x13-y13-z13}O₂ [Chemical Formula 13]

In Chemical Formula 13, 0.9≤a13≤1.8, 0.3≤x13≤0.98, 0.01≤y13≤0.69, 0.01≤z13≤0.69, M¹⁴ is selected from Al, Mn, and a combination thereof, and M¹⁵ is selected from B, Ce, Cr, F, Mg, Mo, Nb, P, S, Si, Sr, Ti, V, W, Zr, and a combination thereof.

In Chemical Formula 13, 0.4≤x13≤0.98, 0.01≤y13≤0.59, and 0.01≤z13≤0.59; 0.5≤x13≤0.98, 0.01≤y13≤0.49, and 0.01≤z13≤0.49; 0.6≤x13≤0.98, 0.01≤y13≤0.39, and 0.01≤z13≤0.39; 0.7≤x13≤0.98, 0.01≤y13≤0.29, and 0.01≤z13≤0.29; 0.8≤x13≤0.98, 0.01≤y13≤0.19, and 0.01≤z13≤0.19; or 0.9≤x13≤0.98, 0.01≤y13≤0.09, and 0.01≤z13≤0.09.

For more specific examples, an LCO-based positive electrode active material, a high-Ni NCA-based positive electrode active material, or a combination thereof (representatively, LiCoO₂, LiNi_{0.91}Co_{0.07}Al_{0.02}O₂, LiNi_{0.82}Co_{0.11}Mn_{0.07}O₂, or a combination thereof) may be used as the positive electrode active material.

A content of the positive electrode active material may be 85 wt % to 99 wt %, for example 90 wt % to 95 wt % based on a total weight of the positive electrode active material layer. Each content of the binder and the conductive material may be 1 wt % to 5 wt % based on a total weight of the positive electrode active material layer.

The binder improves binding properties of positive electrode active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used to impart conductivity to the electrode, and any material may be used as long as it does not cause chemical change in the battery to be configured and is an electron conductive material. Examples of the conductive material may include a carbon-based material such as natural graphite, artificial graphite, carbon black, acetylene black, ketjen black, carbon fiber, carbon nanotube, and the like; a metal-based material of a metal powder or a metal fiber, and the like including copper, nickel, aluminum silver, and the like; a conductive polymer such as a polyphenylene derivative; or a mixture thereof. An aluminum foil may be used as the positive electrode current collector, but is not limited thereto.

### Negative Electrode

The negative electrode for a rechargeable lithium battery includes a current collector and a negative electrode active material layer formed on the current collector and including a negative electrode active material.

The negative electrode active material may include a material that reversibly intercalates/deintercalates lithium ions, a lithium metal, a lithium metal alloy, a material capable of doping and dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

Meanwhile, the negative electrode may include a carbon-based negative electrode active material, a silicon-based negative electrode active material, or a combination thereof as a negative electrode active material.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content of silicon may be 10 wt % to 50 wt % based on a total weight of the silicon-carbon composite. In addition, the content of the crystalline carbon may be 10 wt % to 70 wt % based on a total weight of the silicon-carbon composite, and the content of the amorphous carbon may be 20 wt % to 40 wt % based on a total weight of the silicon-carbon composite. In addition, a thickness of the amorphous carbon coating layer may be 5 nm to 100 nm. An average particle diameter (D50) of the silicon particles may be 10 nm to 20 μm. The average particle diameter (D50) of the silicon particles may be preferably 10 nm to 200 nm. The silicon particles may exist in an oxidized form, and in this case, an atomic content ratio of Si:O in the silicon particles indicating a degree of oxidation may be a weight ratio of 99:1 to 33:66. The silicon particles may be SiOₓ particles, and in this case, the range of x in SiOₓ may be greater than 0 and less than 2. In the present specification, unless otherwise defined, an average particle diameter (D50) indicates a diameter of particles having a cumulative volume of 50 volume % in the particle size distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed and used, the mixing ratio may be a weight ratio of 1:99 to 90:10. For example, a negative electrode active material may be used in which silicon and artificial graphite are mixed in a ratio of 1:99 to 90:10 or 1:99 to 10:90.

In the negative electrode active material layer, the negative electrode active material may be included in an amount of 50 wt % to 99 wt % or 60 wt % to 95 wt % based on a total weight of the negative electrode active material layer.

In an embodiment, the negative electrode active material layer further includes a binder, and may optionally further include a conductive material. Each content of the binder and conductive material in the negative electrode active material layer may be 1 wt % to 5 wt % based on a total weight of the negative electrode active material layer.

The binder serves to well adhere the negative electrode active material particles to each other and also to adhere the negative electrode active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. As the alkali metal, Na, K or Li may be used. The amount of the thickener used may be 0.1 parts by weight to 3 parts by weight based on 100 parts by weight of the negative electrode active material.

The conductive material is included to provide electrode conductivity. Any electrically conductive material may be used as a conductive material unless it causes a chemical change in a battery. Examples of the conductive material include a carbon-based material such as natural graphite, artificial graphite, carbon black, acetylene black, ketjen black, a carbon fiber, carbon nanotube, and the like; a metal-based material of a metal powder or a metal fiber including copper, nickel, aluminum silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

### Separator

The separator separates a positive electrode and a negative electrode and provides a transporting passage for lithium ions and may be any generally-used separator in a lithium ion battery. In other words, it may have low resistance to ion transport and excellent impregnation for an electrolyte solution. For example, separator may be selected from a glass fiber, polyester, TEFLON, polyethylene, polypropylene, polytetrafluoroethylene, or a combination thereof. It may have a form of a non-woven fabric or a woven fabric. For example, lithium ion batteries mainly use polyolefin polymer separators such as polyethylene and polypropylene, and coated separators including ceramic components or polymer materials may be used to secure heat resistance or mechanical strength, and may optionally be used in a single-layer or multi-layer structure.

In order to secure heat resistance or mechanical strength, a separator coated with inorganic filler particles and/or an adhesive in a single-layer or multi-layer structure may be used.

Specifically, the coating layer of the separator may further include inorganic filler particles. The inorganic filler particles may be a metal oxide, a semi-metal oxide, or a combination thereof. Specifically, the inorganic filler particles may be one or more selected from alumina (Al₂O₃), boehmite, BaSO₄, MgO, Mg(OH)₂, clay, silica (SiO₂), and (TiO₂). The alumina, silica, and the like have a small particle size, and thus it is easy to make a dispersion.

For example, the inorganic filler particles may be Al₂O₃, SiO₂, TiO₂, SnO₂, CeO₂, NiO, CaO, ZnO, MgO, ZrO₂, Y₂O₃, SrTiO₃, BaTiO₃, MgF₂, Mg(OH)₂, or a combination thereof. The inorganic filler particles may have a sphere, plate shape, fiber shape, etc., but are not limited thereto, and any form usable in the art may be used.

The plate-shaped inorganic filler particles include, for example, alumina and boehmite. In this case, a reduction in the area of the separator at a high temperature may be further suppressed, a relatively large degree of porosity may be secured, and characteristics may be improved when evaluating the penetration of a lithium battery.

When the inorganic filler particles are sheet-shaped or fiber-shaped, the inorganic filler particles may have an aspect ratio of about 1:5 to 1:100. For example, the aspect ratio may be about 1:10 to 1:100. For example, the aspect ratio may be about 1:5 to 1:50. For example, the aspect ratio may be about 1:10 to 1:50.

The sheet-shaped inorganic filler particles may have a length ratio of a major axis to a minor axis of 1 to 3 on a planar surface. For example, the length ratio of a major axis to a minor axis on the planar surface may be 1 to 2. For example, the length ratio of a major axis to a minor axis on the planar surface may be about 1. The aspect ratio and the length ratio of a major axis to a minor axis may be measured through a scanning electron microscope (SEM). Within the aspect ratio range and the length ratio range of a major axis to a minor axis, a separator may be suppressed from contraction, securing relatively improved porosity may be secured and improving penetration characteristics of a lithium battery.

When the inorganic filler particles are plate-shaped, a planar surface of the inorganic filler particles with one surface of a porous substrate has an average angle of 0° to 30°. For example, the average angle of the planar surface of the inorganic filler particles with one surface of a porous substrate may be converged to 0°. In other words, the planar surface of the inorganic filler particles may be parallel with one surface of a porous substrate. For example, when the average angle of the planar surface of the inorganic filler particles with one surface of a porous substrate is within the ranges, the porous substrate may be effectively suppressed from thermal contraction, providing a separator with a reduced contraction rate.

On the other hand, the coating layer of the separator may include a particle type or solution type polymer adhesive as an adhesive. Examples of the polymer adhesive may include polyvinylidene fluoride (PVdF), a polyvinylidene fluoride-hexafluoropropylene (PVdF-HFP) copolymer, or a combination thereof. When a separator prepared by coating the polymer adhesive at least one surface of the substrate is used, the polymer adhesive is physically cross-linked with binders respectively present in the positive electrode and the negative electrode, improving adherence between the separator and the electrodes.

The coating layer may have thickness of 1 μm to 10 μm and specifically, 1 to 8 μm. The coating layer having a thickness within the ranges may secure excellent heat resistance and in addition, suppress thermal contraction and elution of metal ions.

### Electrolyte

The electrolyte may be a liquid electrolyte including a non-aqueous organic solvent and a lithium salt, which may be impregnated into the separator.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, or aprotic solvent. The carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may be methyl acetate, ethyl acetate, n-propyl acetate, dimethyl acetate, methyl propionate, ethyl propionate, γ-butyrolactone, decanolide, valerolactone, mevalonolactone, caprolactone, and the like. The ether-based solvent may be dibutyl ether, tetraglyme, diglyme, dimethoxyethane, 2-methyltetrahydrofuran, tetrahydrofuran, and the like and the ketone-based solvent may be cyclohexanone, and the like. In addition, the alcohol-based solvent may be ethyl alcohol, isopropyl alcohol, etc. and the aprotic solvent may be nitriles such as R—CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and the like.

The non-aqueous organic solvent may be used alone or in a mixture. When the organic solvent is used in a mixture, the mixture ratio may be controlled in accordance with a desirable battery performance.

In addition, in the case of the carbonate-based solvent, a mixture of a cyclic carbonate and a chain carbonate may be used. In this case, when the cyclic carbonate and the chain carbonate are mixed in a volume ratio of about 1:1 to 1:9, the electrolyte solution may exhibit excellent performance.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be used.

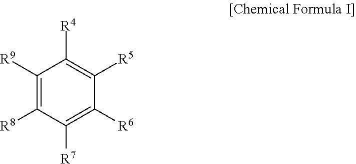

In Chemical Formula I, R⁴ to R⁹ are the same or different and are selected from hydrogen, a halogen, a C1 to C10 alkyl group, a haloalkyl group, and a combination thereof.

Specific examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte solution may further include vinylene carbonate or an ethylene carbonate-based compound of Chemical Formula II in order to improve cycle-life of a battery.

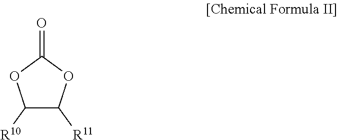

In Chemical Formula II, R¹⁰ and R¹¹ are the same or different, and are selected from hydrogen, a halogen, a cyano group, a nitro group, and fluorinated C1 to C5 alkyl group, provided that at least one of R¹⁰ and R¹¹ is selected from a halogen, a cyano group, a nitro group, and fluorinated C1 to C5 alkyl group, but both of R¹⁰ and R¹¹ are not hydrogen.

Examples of the ethylene-based carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be used within an appropriate range.

The lithium salt dissolved in the non-organic solvent supplies lithium ions in a battery, enables a basic operation of a rechargeable lithium battery, and improves transportation of the lithium ions between positive and negative electrodes.

Examples of the lithium salt may include at least one selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide): LiFSI), LiC₄F₉SO₃, LiClO₄, LiAlO₂, LiAlC₄, LiPO₂F₂, LiN(CₓF₂ₓ₊₁SO₂)(C_{y}F_{2y+1}SO₂), wherein x and y are natural numbers, for example, an integer ranging from 1 to 20, lithium difluoro (bisoxolato) phosphate, LiCl, Lil, LiB (C₂O₄)₂ (lithium bis(oxalato) borate: LiBOB), and lithium difluoro (oxalato) borate (LiDFOB).

The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

Meanwhile, as an additive of the electrolyte solution, other additives may be further included in addition to the aforementioned compound.

The other additives may include at least one of vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), propensultone (PST), propanesultone (PS), lithium tetrafluoroborate (LiBF₄), lithium difluorophosphate (LiPO₂F₂), and 2-fluorobiphenyl (2-FBP).

By further including the aforementioned other additives, cycle-life may be further improved, or gases generated from the positive electrode and the negative electrode may be effectively controlled when stored at a high temperature.

The other additives may be included in an amount of 0.2 to 20 parts by weight, specifically 0.2 to 15 parts by weight, for example, 0.2 to 10 parts by weight, based on 100 parts by weight of the electrolyte solution for a rechargeable lithium battery.

When the content of other additives is as described above, the increase in film resistance may be minimized, thereby contributing to the improvement of battery performance.

Rechargeable lithium batteries may be classified as lithium ion batteries, lithium ion polymer batteries, and lithium polymer batteries according to the presence of a separator and the type of electrolyte used therein. The rechargeable lithium batteries may have a variety of shapes and sizes, and include cylindrical, prismatic, coin, or pouch type batteries, and may be thin film batteries or may be rather bulky in size. Since the structure and manufacturing method of these batteries are well known in the art, a detailed description thereof will be omitted.

### MODE FOR INVENTION

Hereinafter, examples of the present invention and comparative examples are described. It is to be understood, however, that the examples are for the purpose of illustration and are not to be construed as limiting the present invention.

[Evaluation of Cylindrical can-Shaped Exterior Material and Rechargeable Lithium Battery Cell Including the Same]

### Example 1-1

### (1) Manufacturing of Exterior Materials for Rechargeable Lithium Battery

A commercially available cylindrical can-shaped exterior material (Product name: NiS-T, Manufacturer: TCC steel) was used as a substrate, and ZIF-8 with a spray adhesive was sprayed onto the inner surface of the substrate to form a entire-surface coating layer. Herein, the coating layer to the substrate had a thickness ratio (coating layer thickness/substrate thickness) of 1/10 and an area ratio (coating layer area/substrate area) of 1 (i.e., 100 sq %). Specifically, the coating layer had a thickness of 10 μm.

### (2) Manufacturing of Negative Electrode

A negative electrode active material slurry was prepared by mixing 70 wt % of a negative electrode active material prepared by mixing artificial graphite (D50: 16.6 μm) and silicon (D50: 18.0 μm) in a weight ratio of 9:1, 15 wt % of a conductive material (Super-P), and 15 wt % of a binder (PAA (poly acrylic acid)) in water as a solvent. The negative electrode active material slurry was coated on both surfaces of a 10 μm-thick copper foil to a thickness of 71 μm per surface, dried, and compressed to manufacture a negative electrode having a total thickness of 152 μm. Herein, die coating was used as the method for coating the negative electrode active material slurry.

### (3) Manufacturing of Positive Electrode

A positive electrode active material was prepared by mixing 95 wt % of LiNi_{0.91}Co_{0.07}Al_{0.02}O₂ as a positive electrode active material, 3 wt % of polyvinylidene fluoride as a binder, and 2 wt % of ketjen black as a conductive material in an N-methylpyrrolidone solvent. This was coated on both surfaces of a 12 μm-thick aluminum current collector to a thickness of 71 μm per surface, dried, and compressed to manufacture a positive electrode active material layer having a total thickness of 154 μm. Herein, die coating was used as the method for coating the positive electrode active material slurry.

### (4) Manufacturing of Battery Cell

A 14 μm-thick polyethylene separator was prepared and then, inserted between the negative electrode and the positive electrode. Herein, the separator was disposed into contact with the coating surface of each electrode.

After housing the electrode assembly inside the exterior material of which the inner surface was coated with the metal organic framework, an electrolyte solution prepared by mixing ethylene carbonate and diethyl carbonate in a volume ratio of 50:50 and adding 1.10 M of LiPF₆ lithium salt and 10 wt % of FEC thereto was injected thereinto, manufacturing a rechargeable lithium battery cell.

### Example 1-2

In manufacturing the exterior material for a rechargeable lithium battery, MOF-177 was used instead of ZIF-8. Except for this, an exterior material for a rechargeable lithium battery and a rechargeable lithium battery cell of Example 1-2 were manufactured in the same manner as in Example 1-1.

### Example 1-3

In manufacturing the exterior material for a rechargeable lithium battery, AI-MIL-53 was used instead of ZIF-8. Except for this, an exterior material for a rechargeable lithium battery and a rechargeable lithium battery cell of Example 1-3 were manufactured in the same manner as in Example 1-1.

### Example 1-4

In manufacturing the exterior material for a rechargeable lithium battery, Fe-BTC was used instead of ZIF-8. Except for this, an exterior material for a rechargeable lithium battery and a rechargeable lithium battery cell of Example 1-4 were manufactured in the same manner as in Example 1-1.

### Comparative Example 1-1

A rechargeable lithium battery cell of Comparative Example 1-1 was manufactured in the same manner as in Example 1-1 except that a cylindrical can-shaped exterior material itself without the coating layer was used as an exterior material for a rechargeable lithium battery.

### Comparative Example 1-2

In manufacturing the exterior material for a rechargeable lithium battery, zeolite (Product name: A-4 Zeolite, Manufacturer: Nakamura Choukou Co., Ltd.) was used instead of ZIF-8. Except for this, an exterior material for a rechargeable lithium battery and a rechargeable lithium battery cell of Comparative Example 1-2 were manufactured in the same manner as in Example 1-1.

### Comparative Example 1-3

In manufacturing the exterior material for a rechargeable lithium battery, MIL-100 (Fe) represented by the following chemical formula was used instead of ZIF-8. Except for this, an exterior material for a rechargeable lithium battery and a rechargeable lithium battery cell of Comparative Example 1-3 were manufactured in the same manner as in Example 1-1.

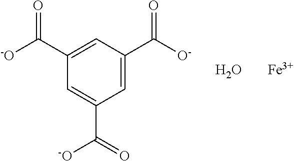

### Comparative Example 1-4

In manufacturing the exterior material for a rechargeable lithium battery, MIL-101 (Fe) represented by the following chemical formula was used instead of ZIF-8. Except for this, an exterior material for a rechargeable lithium battery and a rechargeable lithium battery cell of Comparative Example 1-4 were manufactured in the same manner as in Example 1-1.

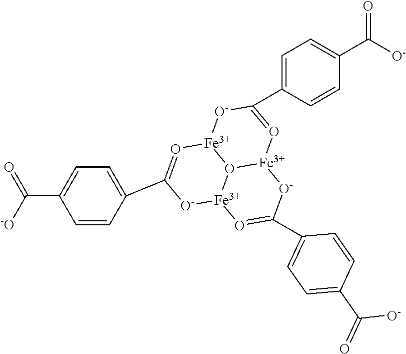

### Comparative Example 1-5

In manufacturing the exterior material for a rechargeable lithium battery, MIL-127 (Fe) represented by the following chemical formula was used instead of ZIF-8. Except for this, an exterior material for a rechargeable lithium battery and a rechargeable lithium battery cell of Comparative Example 1-5 were manufactured in the same manner as in Example 1-1.

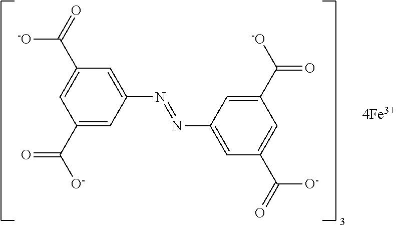

### Comparative Example 1-6

10 In manufacturing the exterior material for a rechargeable lithium battery, MOF-74 (Co) represented by the following chemical formula was used instead of ZIF-8. Except for this, an exterior material for a rechargeable lithium battery and a rechargeable lithium battery cell of Comparative Example 1-6 were manufactured in the same manner as in Example 1-1.

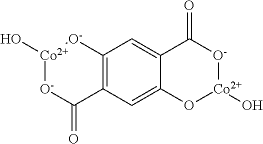

### Comparative Example 1-7

In manufacturing the exterior material for a rechargeable lithium battery, Cu-BTC represented by the following chemical formula was used instead of ZIF-8. Except for this, an exterior material for a rechargeable lithium battery and a rechargeable lithium battery cell of Comparative Example 1-7 were manufactured in the same manner as in Example 1-1.

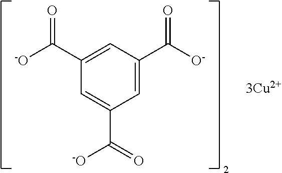

### Comparative Example 1-8

In manufacturing the exterior material for a rechargeable lithium battery, CPO-27 was used instead of ZIF-8. Except for this, an exterior material for a rechargeable lithium battery and a rechargeable lithium battery cell of Comparative Example 1-8 were manufactured in the same manner as in Example 1-1.

### Evaluation Example 1-1: High-Temperature CID Evaluation of Cylindrical

### Can-Type Rechargeable Lithium Battery Cell

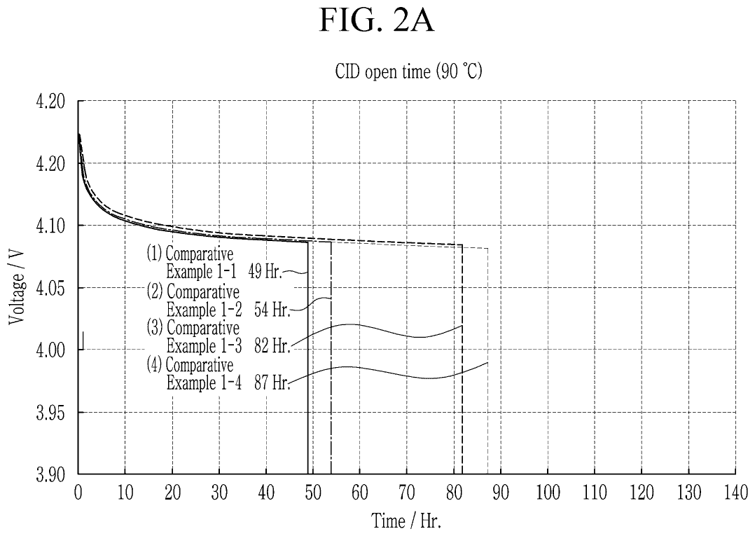

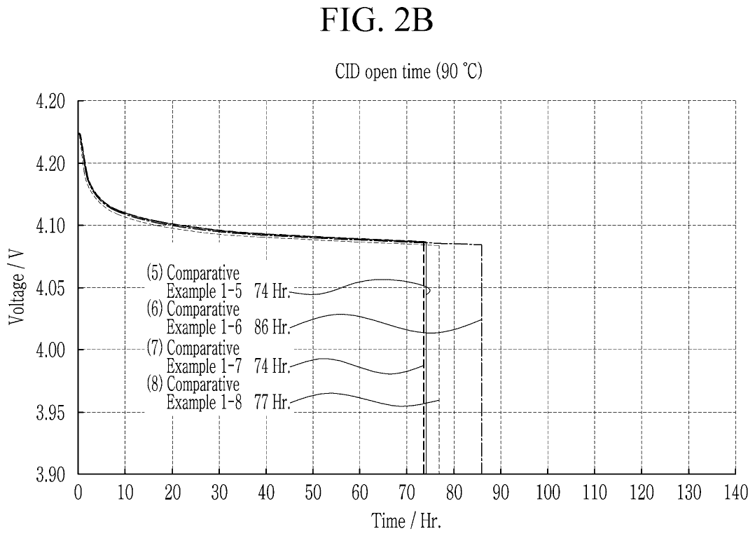

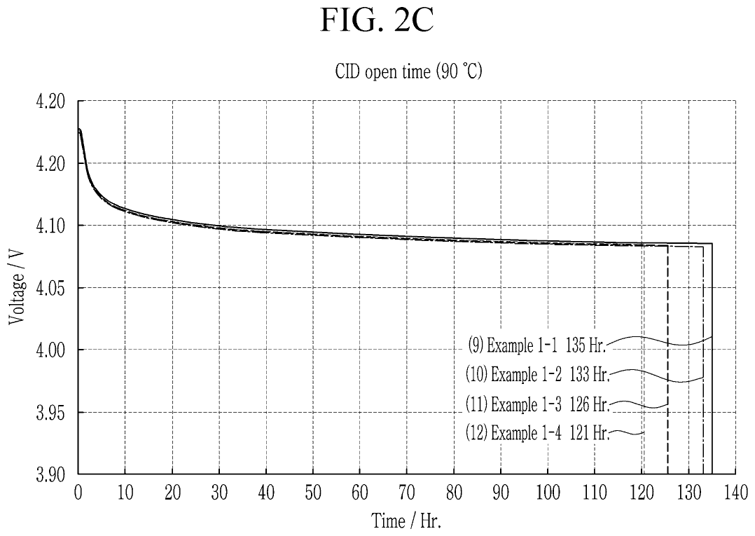

The cylindrical can-type rechargeable lithium battery cells of Example 1-1 to 1-4 and Comparative Examples 1-1 to 1-8 were evaluated with respect to open time of each current interruptive device (CID) at a high temperature, and the results are shown in FIGS. 2a to 2c.

Specifically, the cylindrical can-type rechargeable lithium battery cells were measured with respect to an open circuit voltage (OCV) in a 90° C. temperature chamber.

Referring to FIGS. 2A to 2C, the rechargeable lithium battery cells including a cylindrical can-shaped exterior material coated with a metal organic framework on the inner surface (Examples 1-1 to 1-4 and Comparative Examples 1-2 to 1-8), compared with the rechargeable lithium battery cell using a cylindrical can-shaped exterior material having no coating layer (Comparative Example 1-1), exhibited a small amount of gas generated at the high temperature of 90° C., which slowed an increase in intracellular pressure and delayed opening of CID (current interrupt device).

In particular, among the rechargeable lithium battery cells including a cylindrical can-shaped exterior material coated with a metal organic frame network on the inner surface, the case of applying at least one metal organic framework selected from ZIF-8, MOF-177, AI-MIL-53, and Fe-BTC (Examples 1-1 to 1-4), compared with the case of applying other metal organic frameworks such as MIL-100 (Fe), MIL-101 (Fe), MIL-127 (Fe), MOF-74 (Co), Cu-BTC, CPO-27, and the like (Comparative Examples 1-3 to 1-8) as well as the case of applying zeolite (Comparative Example 1-2), exhibited a significant excellent gas capture effect, which confirmed that the metal organic frame network coated on the inner surface of the cylindrical can-shaped exterior material more effectively captured gas components (e.g., H₂, CO, CO₂, etc.), which might be generated in a degradation mode of the rechargeable lithium battery cells than the other metal organic frameworks.

On the other hand, among the rechargeable lithium battery cells of Examples 1-1 to 1-4, the cell of Example 1-1 using a cylindrical can-shaped exterior material coated with ZIF-8 exhibited a significantly small amount of gas generated. This means that among the ZIF-8, MOF-177, AI-MIL-53, and Fe-BTC, the ZIF-8 the most maximized the physical and chemical adsorption effect of gas components (e.g., H₂, CO, CO₂, etc.) generated from the rechargeable lithium battery cells due to its molecular structure.

### Evaluation Example 1-2: Evaluation of Thermal Exposure of Cylindrical can Type Rechargeable Lithium Battery Cell

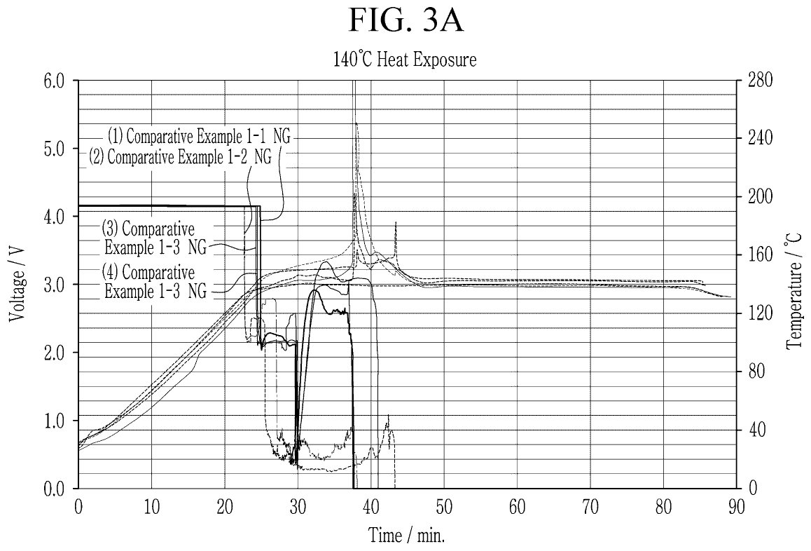

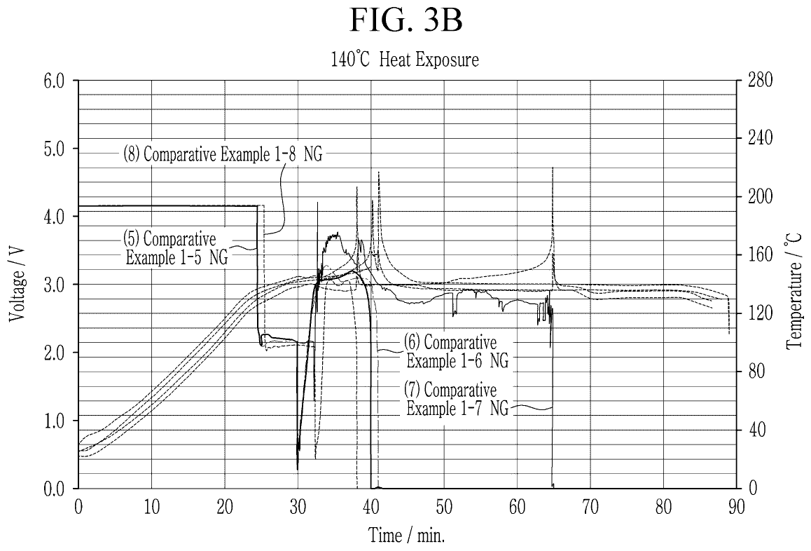

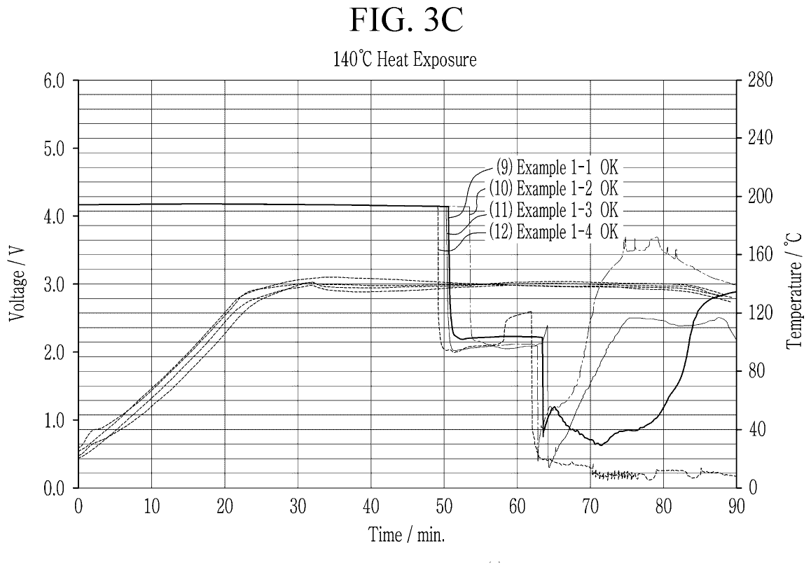

The cylindrical can-type rechargeable lithium battery cells of Examples 1-1 to 1-4 and Comparative Examples 1-1 to 1-8 were measured with respect to a temperature and a voltage when exposed to heat, and the results are shown in FIGS. 3a to 3c.

Specifically, the rechargeable lithium battery cells were twice charged and discharged for formation under the following conditions at 140° C. and then, fully charged again to evaluate the heat exposure.

Charge condition: CC (constant current)/CV (constant voltage), 4.2 V, 0.02 C current cut-off

Discharge condition: CC (constant current), 2.5V

The fully-charged cylindrical rechargeable lithium battery cells were heated to 140° C. at 5° C./min and exposed to the high temperature of 140° C. for 1 hour to measure a cell temperature and a voltage.

Referring to FIGS. 3A to 3C, the rechargeable lithium battery cells including a cylindrical can-shape exterior material coated with a metal organic framework on the inner surface (Examples 1-1 to 1-4 and Comparative Examples 1-2 to 1-8), compared with the rechargeable lithium battery cell using a cylindrical can-shape exterior material itself without the coating layer (Comparative Example 1-1), exhibited a reduced amount of gas generated, even if exposed at the extremely high temperature of 140° C. As a result, the battery cells were prevented from explosion, and particularly, a vent of the cylindrical can-shape battery cells was delayed.

In particular, among the rechargeable lithium battery cells including a cylindrical can-shaped exterior material coated with a metal organic framework on the inner surface, the case of applying at least one metal organic framework selected from ZIF-8, MOF-177, AI-MIL-53, and Fe-BTC (Examples 1-1 to 1-4), compared with the case of using other metal organic frameworks such as MIL-100 (Fe), MIL-101 (Fe), MIL-127 (Fe), MOF-74 (Co), Cu-BTC, CPO-27, and the like (Comparative Examples 1-3 to 1-8) as well as zeolite (Comparative Example 1-2), exhibited a significantly excellent gas capture effect, which was consistent with the result of Evaluation Example 1-1.

On the other hand, among the rechargeable lithium battery cells of Examples 1-1 to 1-4, the cell of Example 1-1 using a cylindrical can-shape exterior material coated with ZIF-8 exhibited a significantly small amount of gas generated, which also was consistent with the result of Evaluation Example 1-1.

### Evaluation Example 1-3: Evaluation According to Coating Thickness and Area of Cylindrical can-Shaped Exterior Material

A cylindrical can-shape exterior material and a rechargeable lithium battery cell were manufactured in the same manner as in Examples 1-1 to 1-4 except that the coating thickness was changed as shown in Table 1.

Independently from this, a cylindrical can-shape exterior material and a rechargeable lithium battery cell were manufactured in the same manner as in Examples 1-1 to 1-4 except that the coating layer area was changed as shown in Table 2.

TABLE 1

| | | 90° C. CID open time (hr) | | | | | | | |
|---|---|---|---|---|---|---|---|---|---|
| | | by coating thickness | | | | | | | |
| | | 0.1 | 0.2 | 1 | 10 | 100 | 1000 | 3000 | 5000 |
| | | μm | μm | μm | μm | μm | μm | μm | μm |
| Coating | None | 49 | 49 | 49 | 49 | 49 | 49 | 49 | 49 |
| material | coating | | | | | | | | |
| | ZIF-8 | 48.5 | 58 | 98 | 135 | 151 | 183 | 201 | 199 |
| | MOF-177 | 49.2 | 55 | 96 | 133 | 149 | 161 | 198 | 198 |
| | Al- | 48.8 | 53 | 92 | 126 | 143 | 158 | 188 | 187 |
| | MIL-53 | | | | | | | | |
| | Fe-BTC | 49.1 | 54 | 88 | 121 | 138 | 152 | 178 | 179 |

TABLE 2

| | | 90° C. CID open time (hr) | | | | | |
|---|---|---|---|---|---|---|---|
| | | by coating area | | | | | |
| | | 1/10 | 2/10 | 4/10 | 6/10 | 8/10 | 9/10 |
| Coating | None | 49 | 49 | 49 | 49 | 49 | 49 |
| material | coating | | | | | | |
| | ZIF-8 | 51 | 52 | 53 | 56 | 57 | 58 |
| | MOF-177 | 51 | 51 | 52 | 54 | 55 | 55 |
| | Al- | 49 | 50 | 51 | 52 | 53 | 53 |
| | MIL-53 | | | | | | |
| | Fe-BTC | 49 | 50 | 51 | 51 | 53 | 54 |

Referring to Tables 1 and 2, even if the same metal organic framework was used, an amount of gas generated was confirmed to be changed depending on a thickness and an area of a coating layer of the metal organic framework coated on a cylindrical can-shape exterior material as a substrate. Accordingly, the thickness and the area of the coating layer may be adjusted to control the amount of gas generated.

### Evaluation Example 1-4: Evaluation According to Coating Pattern of Cylindrical can-Shaped Exterior Material

Except for changing a pattern of a coating layer as shown in Table 3 and FIG. 4, a cylindrical can-shaped exterior material and a rechargeable lithium battery cell were manufactured in the same manner as in Examples 1-1 to 1-4.

Specifically, the coating layer was formed to have each pattern in the following method:
(1) No pattern: An adhesive and MOF were spray-coated on 60 sq % of one surface of a substrate
(2) Point: An adhesive and MOF were spray-coated by inserting a stencil plastic injection with dot-shaped holes
(3) Line: An adhesive and MOF were spray-coated by inserting a stencil plastic injection with line-shaped holes
(4) Cycle: An adhesive and MOF were spray-coated by inserting a stencil plastic injection with circle-shaped holes

TABLE 3

| | | 90° C. CID open time (hr) | | | |
|---|---|---|---|---|---|
| | | by coating type (pattern) | | | |
| | | None | | | |
| | | pattern | | | |
| | | (60% | Pattern 1 | Pattern 2 | Pattern 3 |
| | | coating) | (dot) | (line) | (ring) |
| Coating | None | 49 | 49 | 49 | 49 |
| material | coating | | | | |
| | ZIF-8 | 56 | 57 | 58 | 58 |
| | MOF-177 | 54 | 55 | 55 | 55 |
| | Al-MIL-53 | 52 | 53 | 52 | 53 |
| | Fe-BTC | 51 | 53 | 53 | 52 |

Referring to Table 3, even if the same metal organic framework was used, an amount of gas generated was confirmed to vary depending on a pattern coated on a cylindrical can-shape exterior material as a substrate. Accordingly, the pattern of the coating layer was confirmed to be adjusted to control the amount of gas generated.

### [Evaluation of Pouch-Shaped Exterior Material and Rechargeable Lithium Battery Cell Including the Same]

### Example 2-1

An exterior material for a rechargeable lithium battery was manufactured by using a commercially available pouch-shaped exterior material (Product name: a pouch film for a battery, Manufacturer: YoulChon Chemical Co., Ltd.) instead of the cylindrical can-shape exterior material. Except for this, a sheet for a rechargeable lithium battery and a rechargeable lithium battery cell of Example 2-1 were manufactured in the same manner as in Example 1-1.

### Example 2-2

An exterior material for a rechargeable lithium battery was manufactured by using MOF-177 instead of ZIF-8. Except for this, a sheet for a rechargeable lithium battery and a rechargeable lithium battery cell of Example 2-2 were manufactured in the same manner as in Example 2-1.

### Example 2-3

An exterior material for a rechargeable lithium battery was manufactured by using AI-MIL-53 instead of ZIF-8. Except for this, a sheet for a rechargeable lithium battery and a rechargeable lithium battery cell of Example 2-3 were manufactured in the same manner as in Example 2-1.

### Example 2-4

An exterior material for a rechargeable lithium battery was manufactured by using Fe-BTC instead of ZIF-8. Except for this, a sheet for a rechargeable lithium battery and a rechargeable lithium battery cell of Example 2-4 were manufactured in the same manner as in Example 2-1.

### Comparative Example 2-1

A rechargeable lithium battery cell of Comparative Example 2-1 was manufactured in the same manner as in Example 2-1 except that a pouch-shaped exterior material itself without the coating layer was used as the exterior material for a rechargeable lithium battery.

### Comparative Example 2-2

An exterior material for a rechargeable lithium battery was manufactured by using zeolite (Product name: A-4 Zeolite, Manufacturer: Nakamura Choukou Co., Ltd.) instead of ZIF-8. Except for this, an exterior material for a rechargeable lithium battery and a rechargeable lithium battery cell of Comparative Example 2-2 were manufactured in the same manner as in Example 2-1.

### Comparative Example 2-3

An exterior material for a rechargeable lithium battery was manufactured by using MIL-100 (Fe) represented by the following chemical formula instead of ZIF-8. Except for this, an exterior material for a rechargeable lithium battery and a rechargeable lithium battery cell of Comparative Example 2-3 were manufactured in the same manner as in Example 2-1.

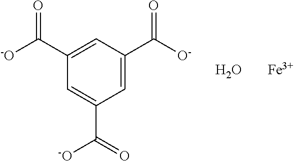

### Comparative Example 2-4

An exterior material for a rechargeable lithium battery was manufactured by using MIL-101 (Fe) represented by the following chemical formula instead of ZIF-8. Except for this, an exterior material for a rechargeable lithium battery and a rechargeable lithium battery cell of Comparative Example 2-4 were manufactured in the same manner as in Example 2-1.

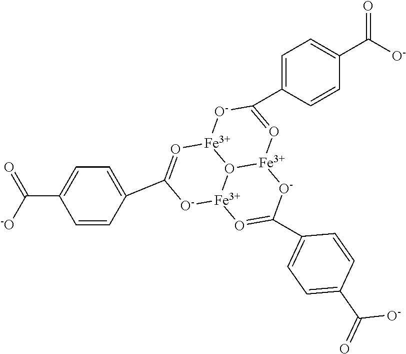

### Comparative Example 2-5

An exterior material for a rechargeable lithium battery was manufactured by using MIL-127 (Fe) represented by the following chemical formula instead of ZIF-8. Except for this, an exterior material for a rechargeable lithium battery and a rechargeable lithium battery cell of Comparative Example 2-5 were manufactured in the same manner as in Example 2-1.

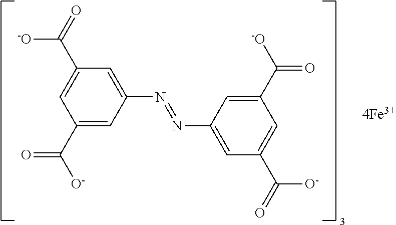

### Comparative Example 2-6

An exterior material for a rechargeable lithium battery was manufactured by using MOF-74(Co) represented by the following chemical formula instead of ZIF-8. Except for this, an exterior material for a rechargeable lithium battery and a rechargeable lithium battery cell of Comparative Example 2-6 were manufactured in the same manner as in Example 2-1.

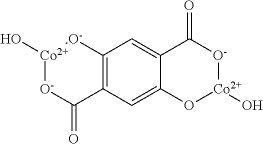

### Comparative Example 2-7

An exterior material for a rechargeable lithium battery was manufactured by using Cu-BTC represented by the following chemical formula instead of ZIF-8. Except for this, an exterior material for a rechargeable lithium battery and a rechargeable lithium battery cell of Comparative Example 2-7 were manufactured in the same manner as in Example 2-1.

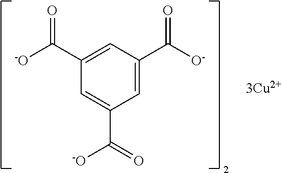

### Comparative Example 2-8

An exterior material for a rechargeable lithium battery was manufactured by using CPO-27 instead of ZIF-8. Except for this, an exterior material for a rechargeable lithium battery and a rechargeable lithium battery cell of Comparative Example 2-8 were manufactured in the same manner as in Example 2-1.

### Evaluation Example 2-1: Overcharge Evaluation of Pouch-Type Rechargeable Lithium Battery Cell

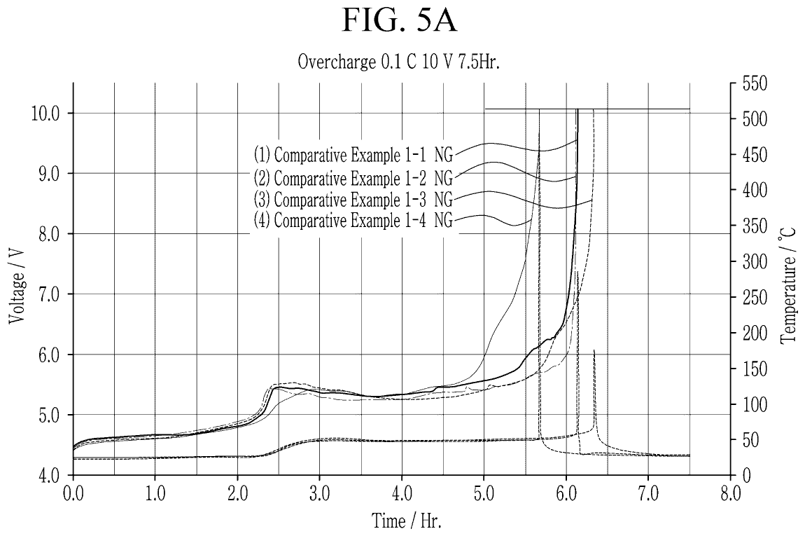

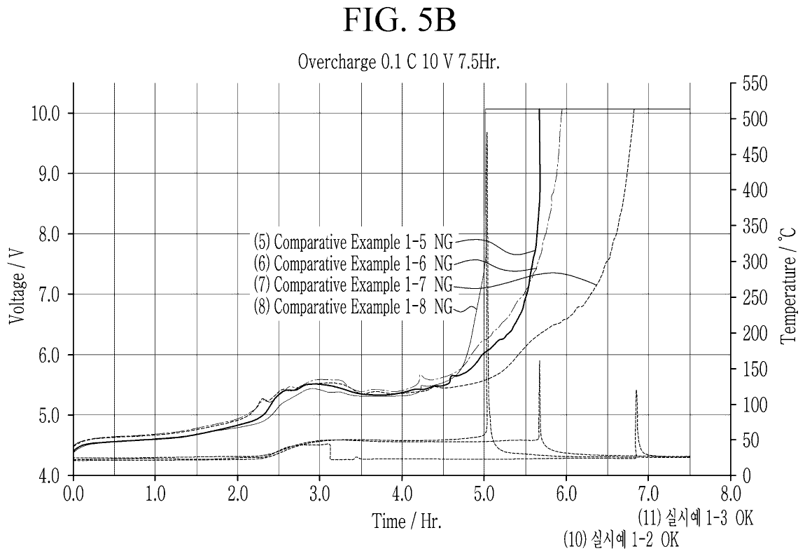

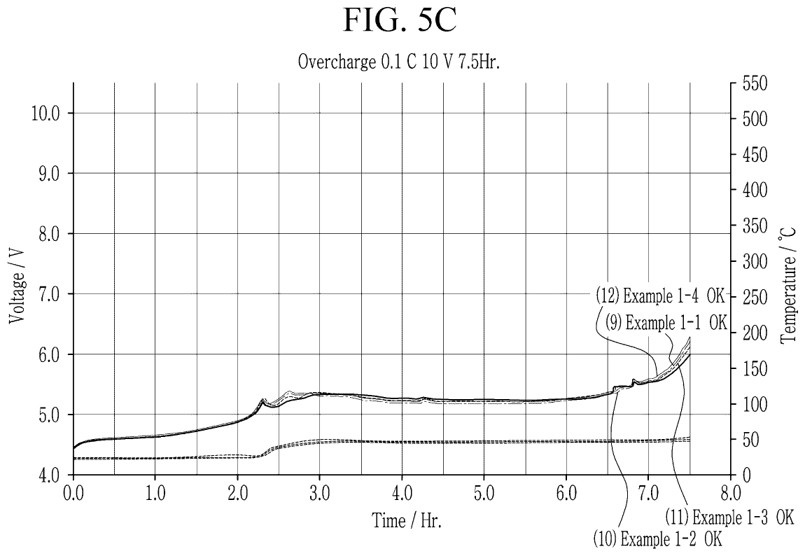

The rechargeable lithium battery cells of Examples 2-1 to 2-4 and Comparative Examples 2-1 to 2-8 were respectively evaluated with respect to cell explosion or not during the overcharge, and the results are shown in FIGS. 5a to 5c.

Specifically, the rechargeable lithium battery cells were subjected to the overcharge evaluation at an ambient temperature in an explosion-proof chamber under the following condition.

Overcharge condition: 0.2 C CC (constant current) charge, 10 V, 7.5 Hr.

Referring to FIGS. 5A to 5C, the rechargeable lithium battery cells including a pouch-shaped exterior material coated with a metal organic framework on the inner surface (Examples 2-1 to 2-4 and Comparative Examples 2-2 to 2-8), compared with the rechargeable lithium battery cell using a pouch-shaped exterior material with no coating layer (Comparative Example 2-1), were confirmed to exhibit a small amount of gas generated during the overcharge, wherein the cell overvoltage less rapildy increased and did not reach 10 V within 7.5 hours. On the contrary, because the pouch cell using no MOF exploded, which created an environment that electrons and lithium ions could not move from a negative electrode to a positive electrode, its voltage reached 10 V, which was an infinite potential difference that could be measured by an overcharge equipment.

In particular, among the rechargeable lithium battery cells including a pouch-shaped exterior material coated with a metal organic framework on the inner surface, the case of applying at least one metal organic framework selected from ZIF-8, MOF-177, AI-MIL-53, and Fe-BTC (Examples 2-1 to 2-4), compared with the case of using other metal organic frameworks such as MIL-100 (Fe), MIL-101 (Fe), MIL-127 (Fe), MOF-74 (Co), Cu-BTC, CPO-27, and the like (Comparative Examples 2-3 to 2-8) as well as zeolite (Comparative Example 2-2), exhibited a significantly excellent gas capture effect, which was consistent with the result of Evaluation Example 1-1.

On the other hand, among the rechargeable lithium battery cells of Examples 2-1 to 2-4, the cell of Example 2-1 using a pouch-shaped exterior material coated with ZIF-8 exhibited a significantly small amount of gas generated, which also was consistent with the result of Evaluation Example 1-1.

### Evaluation Example 2-2: Evaluation According to Coating Thickness and Area of Pouch-Shaped Exterior Material

A pouch-shaped exterior material and a rechargeable lithium battery cell were manufactured in the same manner as in Examples 2-1 to 2-4 except that the coating layer thickness was changed as shown in Table 4.

Independently from this, a pouch-shaped exterior material and a rechargeable lithium battery cell were manufactured in the same manner as in Examples 2-1 to 2-4 except that the coating layer area was changed as shown in Table 5.

TABLE 4

| | | Cell explosion time (hr) between | | | | | | | |
|---|---|---|---|---|---|---|---|---|---|
| | | 0.2 C and 10 V overcharge | | | | | | | |
| | | evaluations by coating thickness | | | | | | | |
| | | 0.1 | 0.2 | 1 | 10 | 100 | 1000 | 3000 | 5000 |
| | | μm | μm | μm | μm | μm | μm | μm | μm |
| Coating | None | 6.2 | 6.2 | 6.2 | 6.2 | 6.2 | 6.2 | 6.2 | 6.2 |
| material | coating | | | | | | | | |
| | ZIF-8 | 6.3 | 9.5 | 10 | 12 | 15 | 18 | 21 | 21 |
| | MOF-177 | 6.2 | 8.8 | 9.8 | 11 | 14 | 17 | 20 | 20 |
| | Al- | 6.1 | 7.4 | 8.8 | 10 | 13 | 18 | 19 | 19 |
| | MIL-53 | | | | | | | | |
| | Fe-BTC | 6.2 | 7.2 | 8.2 | 11 | 12 | 16 | 19 | 18 |

TABLE 5

| | | Cell explosion time (hr) between | | | | | |
|---|---|---|---|---|---|---|---|
| | | 0.2 C and 10 V overcharge | | | | | |
| | | evaluations by coating area | | | | | |
| | | 1/10 | 2/10 | 4/10 | 6/10 | 8/10 | 9/10 |
| Coating | None | 6.2 | 6.2 | 6.2 | 6.2 | 6.2 | 6.2 |
| material | coating | | | | | | |
| | ZIF-8 | 7.8 | 8.4 | 8.8 | 9.1 | 9.2 | 9.5 |
| | MOF-177 | 7.4 | 8.0 | 8.5 | 8.7 | 8.7 | 8.8 |
| | Al- | 6.5 | 7.0 | 7.1 | 7.3 | 7.4 | 7.4 |
| | MIL-53 | | | | | | |
| | Fe-BTC | 6.4 | 7.0 | 7.0 | 7.2 | 7.3 | 7.3 |

Referring to Tables 4 and 5, even if the same metal organic framework was used, an amount of gas generated was confirmed to vary depending on a thickness and an area of the metal organic framework coated on the pouch-shaped exterior material as a substrate. Accordingly, the thickness and area of the coating layer was confirmed to be adjusted to control the amount of gas generated.

### Evaluation Example 2-3: Evaluation According to Coating Type (Pattern) of Pouch-Shaped Exterior Material

A pouch-shaped exterior material and a rechargeable lithium battery cell were manufactured in the same manner as in Examples 1-1 to 1-4 except that the coating layer pattern was changed as shown in Table 6 and FIG. 4.

Specifically, a method of forming the coating layer into each pattern is the same as in Evaluation Example 1-4:

TABLE 6

| | | Cell explosion time (hr) between | | | |
|---|---|---|---|---|---|
| | | 0.2 C 10 V overcharge evaluations | | | |
| | | by coating type (pattern) | | | |
| | | None | | | |
| | | pattern | | | |
| | | (60 sq % | Pattern 1 | Pattern 2 | Pattern 3 |
| | | coating) | (dot) | (line) | (ring) |
| Coating | None | 6.2 | 6.2 | 6.2 | 6.2 |
| material | coating | | | | |
| | ZIF-8 | 9.1 | 9.3 | 9.5 | 9.5 |
| | MOF-177 | 8.7 | 8.8 | 8.8 | 8.7 |
| | Al-MIL-53 | 7.3 | 7.4 | 7.4 | 7.4 |
| | Fe-BTC | 7.2 | 7.3 | 7.2 | 7.3 |

Referring to Table 6, even if the same metal organic framework was used, an amount of gas generated was confirmed to vary depending on a pattern of the metal organic framework coated on the pouch-shaped exterior material as a substrate. Accordingly, the coating layer pattern was confirmed to be adjusted to control the amount of gas generated. While this disclosure has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

[Description of Symbols]

| | |
|---|---|
| 100: rechargeable lithium battery | 112: negative electrode |
| 113: separator | 114: positive electrode |
| 120: battery case | 140: sealing member |

1. An exterior material for a rechargeable lithium battery, the exterior material comprising
a substrate; and
a coating layer located on the inner surface of the substrate and including a metal organic framework (MOF) comprising at least one of ZIF-8, MOF-177, Al-MIL-53, and Fe-BTC.

2. The exterior material for a rechargeable lithium battery as claimed in claim 1, wherein a thickness ratio of the coating layer to the substrate is 1/1000 to 5.

3. The exterior material for a rechargeable lithium battery as claimed in claim 2, wherein the thickness of the coating layer is 200 nm to 5 mm.

4. The exterior material for a rechargeable lithium battery as claimed in claim 1, wherein an area ratio of the coating layer to the substrate is 2/10 to 1.

5. The exterior material for a rechargeable lithium battery as claimed in claim 1, wherein the coating layer is patterned in a shape of a plurality of circles, stripes, rings, or a combination thereof.

6. The exterior material for a rechargeable lithium battery as claimed in claim 1, wherein the exterior material is an exterior material for a can type rechargeable lithium battery or an exterior material for a pouch type rechargeable lithium battery.

7. A rechargeable lithium battery, comprising the exterior material for a rechargeable lithium battery as claimed in claim 1.

8. The rechargeable lithium battery as claimed in claim 7, wherein the rechargeable lithium battery includes an assembly in which a positive electrode; a separator; and a negative electrode are sequentially stacked, the assembly is housed inside the exterior material for a rechargeable lithium battery.

9. The rechargeable lithium battery as claimed in claim 8, wherein the positive electrode includes a composite oxide of lithium and at least one metal selected from nickel, cobalt, manganese, and aluminum as a positive electrode active material.
